(19) United States
(12) Patent Application Publication
(10) Pub. No.: US 2009/0210599 A1
(43) Pub. Date: Aug. 20, 2009

(54) Electronic Circuit

(75) Inventor: Tsuyoshi Nakamura, Fukuoka (JP)

Correspondence Address: WENDEROTH, LIND & PONACK L.L.P., 1030 15th Street, N.W., Suite 400 East, Washington, DC, 20005-1503, US

(73) Assignee: MATSUSHITA ELECTRIC INDUSTRIAL CO., LTD., Osaka (JP)

(21) Appl. No.: 11/794,668

(22) PCT Filed: Jan. 11, 2006
(86) PCT No.: PCT/JP2006/300660

§ 371 Date: Jul. 3, 2007

(30) Foreign Application Priority Data
Jan. 19, 2005 (JP) 2005-011126

(51) Int. Cl. G06F 13/24

(52) U.S. Cl. 710/260

(57) ABSTRACT

An electronic circuit comprises a bus (300), a processor unit (100), and an operating sector (400). The operating sector (400) includes a first operating unit (421), a second operating unit (422), a third operating unit (423), registers (431) to (434), a first selector (441), a second selector (442), a switching unit (450), and a controller (410). For example, when the processor unit (100) substitutes processing of the second operating unit (422), the switching unit (450) selects output data (D12) of the first operating unit (421), and the second selector (442) selects processing result (D10) that is performed by the processor unit (100). Then, the switching unit (450) inputs the result into the third operating unit (423).

### TECHNICAL FIELD

The present invention relates to an electronic circuit in which a part of processing of operating units thereof can be substituted by a processor unit thereof.

### BACKGROUND ART

An electronic circuit possessing a processor unit is used as one of the methods to install a certain application in equipment. The processor unit is suitable to realize various functions by programs; however, the processor unit sometimes encounters difficulties in fulfilling a target performance. There is a tendency that in the electronic circuit for signal processing used for the latest AV equipment etc., the target performance required for the electronic circuit is alternatively fulfilled by adding a high-speed operating unit to the electronic circuit in order to assist the performance of the processor unit.

As disclosed in Document 1 (“Development of One Chip LSI for MPEG 2 Video Encoder”; Tadao Matsuura et al., Sharp Technical Report, No. 72, December 1998, pp. 42-45.), the latest image-processing codec LSI is commonly composed of a CPU core block as a processor unit, and logical blocks as operating units (for example, a motion detection/motion compensation block, a DCT block, a quantization block, a variable length encoding block, and so on). These logical blocks are specialized circuits and do not comprise a mechanism which can change their functions.

FIG. 7 is a block diagram of a common conventional electronic circuit in which operating units are added to a processor unit. In the conventional electronic circuit shown in FIG. 7, a processor unit 1 and an operating sector 2 are connected via a data bus 11. The operating sector 2 comprises a controller 3, a register 4, a first operating unit 5, a register 6, a second operating unit 7, a register 8, a third operating unit 9, and a register 10. Signal lines 15 and 16 are installed in between the processor unit 1 and the controller 3. The signal line 15 sends a control signal by which the processor unit 1 controls operation of the operating sector 2. The signal line 16 sends a status signal by which the processor unit 1 is notified of the state of the operating sector 2.

In the following, the outline of operation of the conventional electronic circuit shown in FIG. 7 is explained. The processor unit 1 sets data of 4-bit length in the register 4 via the data buses 12, the data buses 11, and the data buses 13. Next, the processor unit 1 sends to the controller 3 via the signal line 15 a control signal for starting the operating sector 2.

The controller 3 receives the control signal from the processor unit 1, and then gives a start instruction to the first operating unit 5, the second operating unit 7, and the third operating unit 9. A calculation result is sent to the processor unit 1 via the data bus 14, the data bus 11, and the data bus 12. The controller 3 sends notification of processing completion to the processor unit 1 via the signal line 16.

The processor unit 1 receives the notification of processing completion from the controller 3, and then acquires the calculation result in the data bus 11.

As explained above, in the conventional electronic circuit shown in FIG. 7, the process ability of the electronic circuit is improved by the parallel operation of the processor unit 1 and the operating sector 2. However, the conventional electronic circuit shown in FIG. 7 has the following problems in calculation processing.

Assume, for example, that data of 4-bit length is set to the register 4, the first operating unit 5 multiplies the input data by a value “3”, the second operating unit 7 adds the input data and a value “1”, and the third operating unit 9 divides the input data by a value “2”.

When a value “5” is set to the register 4 as the data of 4-bit length, the output of the first operating unit 5 is “5*3=15”, the output of the second operating unit 7 is “15+1=0”, and the output of the operating unit 9 is “0/2=0”. Here, the calculation result of the second operating unit 7 is supposed to be “15+1=16”. However, the calculation result of the second operating unit 7 becomes a value “0”, since the data bus 13 and the data bus 14 are of a 4-bit length, and a carried upper bit is rounded down.

For some applications, round-down is not permitted, and saturation manipulation may be required. This case can not be coped with by the electronic circuit shown in FIG. 7; therefore, it is necessary to newly install an operating unit possessing the saturation manipulation function to the second operating unit 7. The saturation manipulation is to change the calculation result to the maximum value (or the minimum value) that can be expressed by the calculation word length or data bus length, for example, when the calculation result exceeds the upper limit (or the lower limit) of the calculation word length or data bus length. In the above-mentioned explanation, when the saturation manipulation function is added to the second operating unit 7, the output of the case will become the maximum value “15”.

As another problem in the prior art, when specifications of an application are changed, for example, regarding the calculation of the first operating unit 5, from the current specifications of “to multiply the input data by 3” to new specifications of “to multiply the input data by 5”, the conventional electronic circuit can not cope with such a specification change, unless the operating sector 2 is substituted by a new operating sector.

Furthermore, when one of the first operating unit 5, the second operating unit 7, and the third operating unit 9 falls into functional disorder, the conventional electronic circuit can not cope with the situation any further; therefore, discarding the operating sector 2 itself. For a latest large-scale electronic circuit with operating units for signal processing, for example, discarding the whole electronic circuit due to a partial functional disorder in the operating units causes a tremendous loss from the economic point of view.

### DISCLOSURE OF THE INVENTION

An object of the present invention is to provide an electronic circuit comprising a processor unit and operating units, in which a part of processing of the operating units can be substituted by the processor unit.

A first aspect of the present invention provides an electronic circuit comprising: a processor unit; and an operating sector connected to the processor unit, wherein the operating sector includes: a controller; a plurality of operating units; and a plurality of selectors. The processor unit is operable to control, through the controller, operation of the plurality of operating units and selection of the plurality of selectors, thereby substituting processing of at least one of the plurality of operating units.

According to the structure of the present invention, the processor unit can substitute the processing of at least one of the operating units of the operating sector. Therefore, when one of the operating units is changed its specifications or falls in malfunctioning, the processor unit can substitute the processing of the operating unit. As a result, the electronic circuit can be continuously used without discarding, with a great merit from the economic point of view.

A second aspect of the present invention provides an electronic circuit comprising: a bus; a processor unit connected to the bus; and an operating sector connected to the bus, wherein the operating sector includes: a controller; n-pieces of operating units (n is an integer equal to or greater than 2); (n−1) pieces of selectors; and a switching unit. An m-th selector among the (n−1) pieces of selectors (m is an integer greater than 0 and smaller than n) is positioned between an m-th operating unit and an (m+1)th operating unit among the n-pieces of operating units, and operable to select either of data outputted by the m-th operating unit and data inputted to the operating sector by the processor unit via the bus, thereby inputting the selected data to the (m+1)th operating unit. The switching unit is operable to select one of n-pieces of data fed respectively by the n-pieces of operating units and output the selected data to the processor unit via the bus. The controller, in response to an instruction by the processor unit, is operable to control selection of the (n−1) pieces of selectors and selection of the switching unit, and to notify the processor unit of results of the selection. Furthermore, the processor unit, upon receipt of the results of the selection, is operable to process the data outputted by the switching unit and to input the processed data to the operating sector, thereby substituting processing of at least one of the plurality of operating units.

According to the structure of the present invention, by switching the selectors and the switching unit, the processing of at least one of the operating units is substituted by the processor unit. Therefore, even when one of the operating units is changed its specifications or falls in malfunctioning, the processing of the operating unit is substituted by the processor unit, thereby, the present electronic circuit executes the target processing thereof duly.

A third aspect of the present invention provides the electronic circuit as defined in the second aspect, wherein the processor unit includes: an interruption controller, and wherein the controller is operable to issue to the interruption controller interruption request requesting substitution of processing of at least one of the n-pieces of operating units.

According to the structure of the present invention, the controller can request the processor unit to substitute the processing of the operating unit, by using the interruption controller which the ordinary processor unit possesses.

A fourth aspect of the present invention the electronic circuit as defined in the second aspect, wherein when an operating unit of the n-pieces of operating units changes contents of processing, the processor unit substitutes the processing of the operating unit.

According to the structure of the present invention, since the electronic circuit can flexibly cope with processing under new specifications that are changed from the original design specifications. Therefore, the electronic circuit is convenient and economical to use.

A fifth aspect of the present invention provides the electronic circuit as defined in the second aspect, wherein when an operating unit of the n-pieces of operating units falls into functional disorder, the processor unit substitutes processing of the operating unit.

According to the structure of the present invention, the electronic circuit can be continuously used without discarding the electronic circuit itself, even when a part of the operating units becomes malfunctioning; therefore, the electronic circuit is economical to use.

A sixth aspect of the present invention provides the electronic circuit as defined in the second aspect, wherein the operating sector includes wired logic circuits.

According to the structure of the present invention, it is possible to realize the electronic circuit which can cope with malfunction or specification changes of a part of the operating units, by using the operating sector of the wired logic circuits operable to perform high-speed calculation.

A seventh aspect of the present invention provides the electronic circuit as defined in the second aspect, wherein the operating sector includes programmable logic circuits.

According to the structure of the present invention, it is possible to realize a highly flexible operating sector, since the contents of control for the controller can be easily changed by re-programming, if necessary.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of an electronic circuit in Embodiment 1 of the present invention;

FIG. 2 is a block diagram of an electronic circuit in Embodiment 2 of the present invention;

FIG. 3 is a flow chart of the electronic circuit in normal operation in Embodiment 2 of the present invention;

FIG. 4 illustrates state transitions of a controller in normal operation in Embodiment 2 of the present invention;

FIG. 5 is a flow chart of the electronic circuit after function alteration in Embodiment 2 of the present invention;

FIG. 6 illustrates state transitions of the controller in operation after function alteration in Embodiment 2 of the present invention; and

FIG. 7 is a block diagram of a conventional electronic circuit in which an operating sector is added to the processor unit.

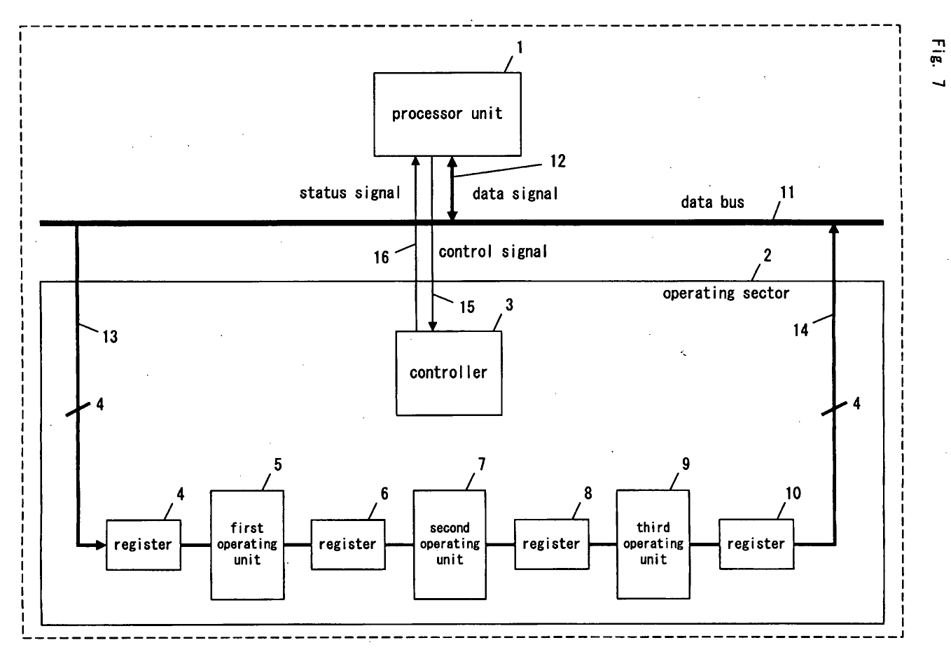

### BEST MODE FOR CARRYING OUT THE INVENTION

In the following, embodiments of the present invention are explained referring to the accompanying drawings.

### Embodiment 1

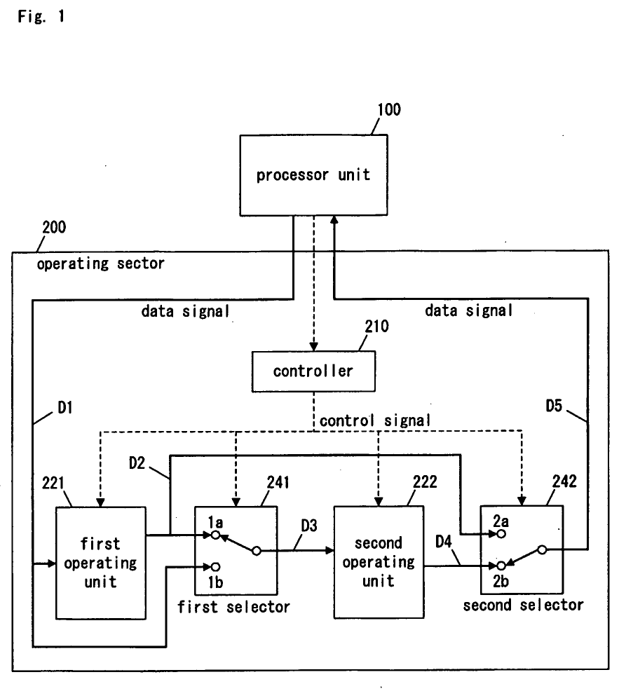

FIG. 1 is a block diagram of an electronic circuit in Embodiment 1 of the present invention.

The electronic circuit of the present embodiment comprises a processor unit 100 and an operating sector 200 connected to the processor unit 100. The operating sector 200 includes a first operating unit 221, a second operating unit 222, a first selector 241, a second selector 242, and a controller 210.

The controller 210, on receipt of the instruction from the processor unit 100, controls the execution of the first operating unit 221 and the second operating unit 222, and the switchover of the first selector 241 and the second selector 242.

The following explains a case where the operating sector 200 of the present embodiment normally executes the predetermined processing. The first operating unit 221 inputs data D1 from the processor unit 100 and performs predetermined processing. The first selector 241 switches the connection to a contact 1a, and selects output data D2 of the first operating unit 221. The second operating unit 222 inputs data D3 selected by the first selector 241 (in this case, it equals the data D2), and performs the predetermined processing. The second selector 242 switches the connection to a contact 2b, and selects output data D4 of the second operating unit 222. The processor unit 100 receives data D5 selected by the second selector 242 (in this case, it equals the data D4), as the processing result of the operating sector 200.

The following explains a case where the processor unit 100 substitutes the processing to be performed by the first operating unit 221, because of a specification change or malfunction of the first operating unit 221 in the operating sector 200 of the present embodiment. The processor unit 100 performs, in substitution, the processing that should be performed by the first operating unit 221 and sends the processed result to the operating sector 200 as the data D1. The first selector 241 switches the connection to a contact 1b and selects the data D1 which the processor unit 100 has sent. The second operating unit 222 inputs the data D3 selected by the first selector 241 (in this case, it equals the data D1 which the processor unit 100 has processed in substitution), performs the predetermined processing, and outputs the data D4. The second selector 242 switches the connection to the contact 2b, and selects the output data D4 of the second operating unit 222. The processor unit 100 receives the data D5 selected by the second selector 242 (in this case, it equals the data D4), as the processing result of the operating sector 200.

Thus, in the electronic circuit of the present embodiment, the processor unit 100 can substitute the processing that should be performed by the first operating unit 221.

The following explains a case where the processor unit 100 substitutes the processing to be performed by the second operating unit 222, because of a specification change or malfunction of the second operating unit 222 in the operating sector 200 of the present embodiment. The first operating unit 221 performs the processing for the data D1 which is sent from the processor unit 100, and outputs the data D2. The second selector 242 switches the connection to a contact 2a, and selects the output data D2 of the first operating unit 221. The processor unit 100 receives the data D5 selected by the second selector 242 (in this case, it equals the data D2 processed by the first operating unit 221), and performs, in substitution, the processing that should be performed by the second operating unit 222.

Thus, in the electronic circuit of the present embodiment, the processor unit 100 can substitute the processing that should be performed by the second operating unit 222.

As explained above, in the electronic circuit of the present embodiment, the processor unit 100 can substitute the processing that should be performed by one of the operating units, which the operating sector 200 possesses. Therefore, when a specification change or malfunction occurs in one of the plurality of operating units, the processing of the operating unit can be substituted by the processor unit. In this way, the electronic circuit can be continuously used, without discarding the operating sector, accompanied by a merit from the economic point of view.

In the above explanation, the operating sector 200 of the present embodiment shown in FIG. 1 possesses two operating units. The electronic circuit of the present embodiment can be applied to a case where the operating sector 200 possesses more than two operating units. In other words, a similar selector to the first selector 241 is inserted in the input side of each operating unit following the second stage. The inserted selector selects either of the output data of the preceding operating unit or the data that is inputted to the operating sector 200 by the processor unit 100, and outputs the selected data to the succeeding operating unit. The selector of the last stage selects one of the data which each operating unit outputs, and sends the selected data to the processor unit 100. Thus, even when the operating sector 200 of the present embodiment possesses more than two operating units, the processing of an operating unit, in which a specification change or malfunction occurs, can be substituted by the processor unit 100.

### Embodiment 2

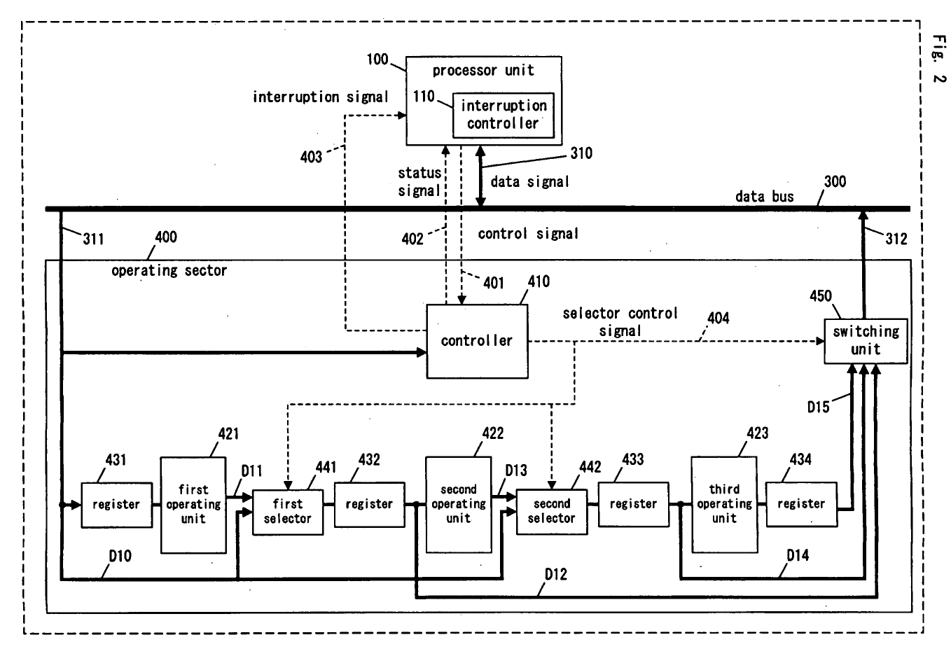

FIG. 2 is the block diagram of the electronic circuit in Embodiment 2 of the present invention.

The electronic circuit of the present embodiment comprises a bus 300, the processor unit 100 connected to the bus 300, and an operating sector 400 connected to the bus 300.

The processor unit 100 includes an interruption controller 110.

The operating sector 400 includes a first operating unit 421; a second operating unit 422; a third operating unit 423; registers 431, 432, and 433, each operable to set data to the respective succeeding operating unit; a register 434 operable to store the calculation result of the third operating unit 423; a first selector 441 operable to switch-over the input of the register 432; a second selector 442 operable to switch-over the input of the register 433; a switching unit 450 operable to select one of the outputs of the operating units; and a controller 410 operable to control the first selector 441, the second selector 442, the switching unit 450, and the operating units 421 to 423.

Referring to FIG. 2, the electronic circuit in normal operation is explained first.

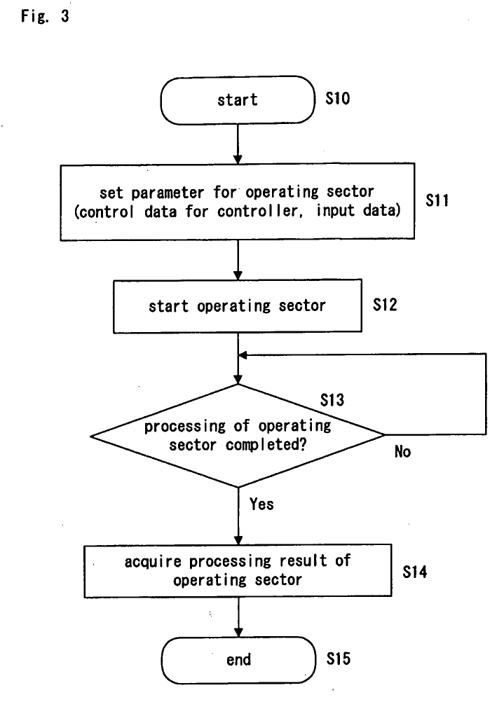

FIG. 3 is the flow chart of the electronic circuit in normal operation in Embodiment 2 of the present invention.

In FIG. 3, the normal operation is started at Step S10. At Step S11, the processor unit 100 sets, to the controller 410, parameters necessary for controlling calculation, via a bus 310, a bus 300, and a local bus 311, and simultaneously sets, to the register 431, input data that should be calculated.

At Step S12, the processor unit 100 sends a control signal to the controller 410 via a control line 401, and starts the operating sector 400.

At Step S13, the controller 410 observes the states of the first operating unit 421, the second operating unit 422, and the third operating unit 423, and judges whether or not the processing is completed in all of the operating units. When the processing is not completed, the judgment result is “No”, and Step S13 is repeated until the processing is completed. After the processing is completed, the controller 410 issues, as the status signal, notification of processing completion in the operating sector 400 to the processor unit 100 via a control line 402. At that time, the judgment result of Step S13 becomes “Yes”, and the control moves to Step S14.

At Step S14, when the processor unit 100 receives the notification of processing completion from the controller 410 via the control line 402, the processor unit 100 acquires the result of calculation processing from the operating sector 400 via a local bus 312, the bus 300, and the bus 310, and ends the normal operation at Step S15.

Next, the state transition of the controller 410 in normal operation is explained in more detail.

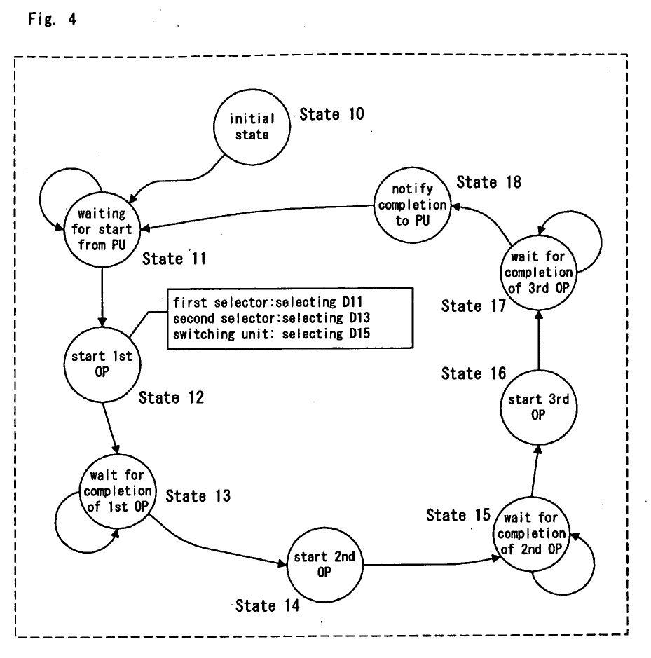

FIG. 4 illustrates state transitions of the controller 410 in normal operation in Embodiment 2 of the present invention.

In FIG. 4, State 10 expresses an initial state in which the electronic circuit is in a reset state.

When the reset for the electronic circuit is cancelled, the state of the controller 410 is transited from State 10 to State 11, which is the state waiting for the start instruction from the processor unit 100 (it is written as “PU” in FIG. 4).

When the start instruction for the operating sector 400 is given by the processor unit 100, the state is transited to State 12. At State 12, the controller 410 controls each selector such that the first selector 441 selects data D11, the second selector 442 selects data D13, and the switching unit 450 selects data D15. Simultaneously, the controller 410 starts the first operating unit 421 (in FIG. 4, it is written as “1st OP”).

At State 13, the controller 410 waits for the completion of calculation processing in the first operating unit 421. After the calculation processing in the first operating unit 421 is completed, the state is transited to State 14.

At State 14, the controller 410 starts the second operating unit 422 (in FIG. 4, it is written as “2nd OP”).

At State 15, the controller 410 waits for the completion of calculation processing in the second operating unit 422. After the calculation processing in the second operating unit 422 is completed, the state is transited to State 16.

At State 16, the controller 410 starts the third operating unit 423 (in FIG. 4, it is written as “3rd OP”).

At State 17, the controller 410 waits for the completion of calculation processing in the third operating unit 423. After the calculating processing in the third operating unit 423 is completed, the state is transited to State 18.

At State 18, the controller 410 issues the notification of processing completion to the processor unit 100. Then, the state is returned to State 11.

By the above-mentioned series of the states, the electric circuit in normal operation of the present embodiment is executed. In addition, the controller 410 does not issue the notification of interruption request to the processor unit 100 in the meantime.

Next, the following explains the operation of the electronic circuit of the present embodiment according specifications that differ from the designed specifications, in other words, the following explains the operation after function alteration.

As an example of the operation after function alteration, it is assumed that data of 4-bit length is set in the register 431, the operating unit 421 multiplies the input data by a value “3”, the second operating unit 422 adds the input data by a value “1”, and the third operating unit 423 divides the input data by a value “2”. It is assumed that the second operating unit 422 is not in possession of the saturation manipulation function in the designed specifications, but required to perform processing with the saturation manipulation function in the specifications in which the function is altered. In order to perform the operation after function alteration, the processor unit 100 in the electronic circuit of the present embodiment substitutes the processing of the second operating unit 422 with the required saturation manipulation function added thereto.

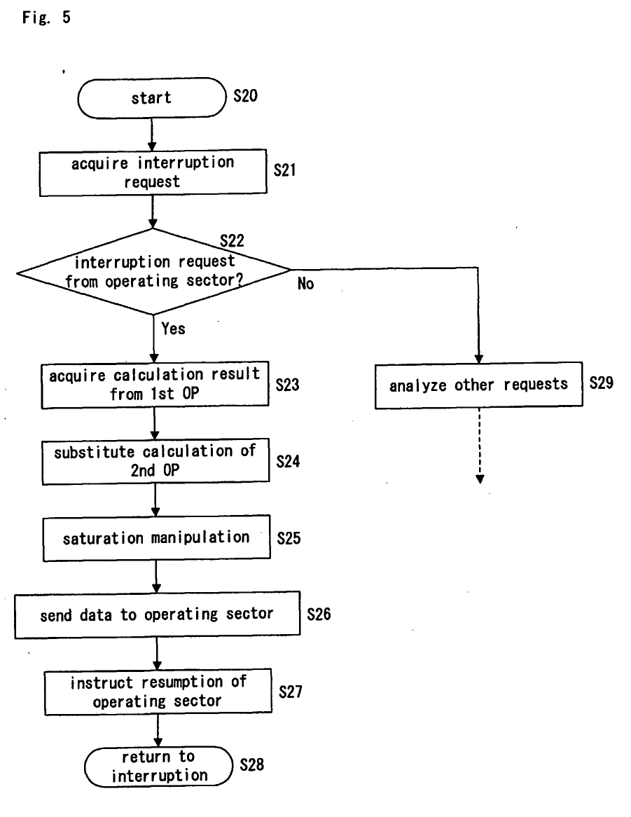

FIG. 5 is the flow chart of the electronic circuit after function alteration in Embodiment 2 of the present invention. Referring to FIG. 2 and FIG. 5, the operation after function alteration for the electronic circuit of the present embodiment is explained.

In FIG. 5, at Step S20, the processor unit 100 starts the operation after function alteration. Then, at Step S21, the processor unit 100 receives the interruption request from the controller 410.

At Step S22, the processor unit 100 judges whether the received interruption request is one from the operating sector 400 or not. When the judgment result is “Yes” (that is, the interruption request is one from the operating sector 400), the control is moved to Step S23. When the judgment result is “No” (that is, the interruption result is one from other than the operating sector 400), the control is moved to Step S29, and the content of the request is analyzed.

At Step S23, the processor unit 100 acquires the data D12 selected by the switching unit 450, via the local bus 312, the bus 300, and the bus 310. The data D12 is the calculation result “5*3=15” of the first operating unit 421 (in FIG. 5, it is written as “1st OP”).

At Step S24, the processor unit 100, using the acquired data, substitutes the addition operation “15+1=16” which should have performed by the second operating unit 422.

At Step S25, the processor unit 100 performs the saturation manipulation to the addition operation result. In this case, since the addition operation result “16” exceeds the maximum value “15” in the 4-bit expression, the addition operation result “16” is changed to the maximum value “15”.

At Step S26, the processor unit 100 sends the maximum value “15”, as the processed result, to the operating sector 400 via the bus 310, the bus 300, and the local bus 311. The maximum value “15”, sent to the operating sector 400, is selected by the second selector 442, and written into the register 433.

At Step S27, the processor unit 100 gives to the operating sector 400 an instruction to resume the execution therein, and returns from the interruption processing at Step S28.

Then, in the operating sector 400, a division calculation “15/2=7” (rounding down the decimal fractions) is performed in the third operating unit 423. As the calculation result of the operating sector 400, the value “7” is sent to the processor unit 100 via the local bus 312, the bus 300, and the bus 310.

Next, the figure is explained, which illustrates the state of the controller 410 in the operation after function alteration, as mentioned above,

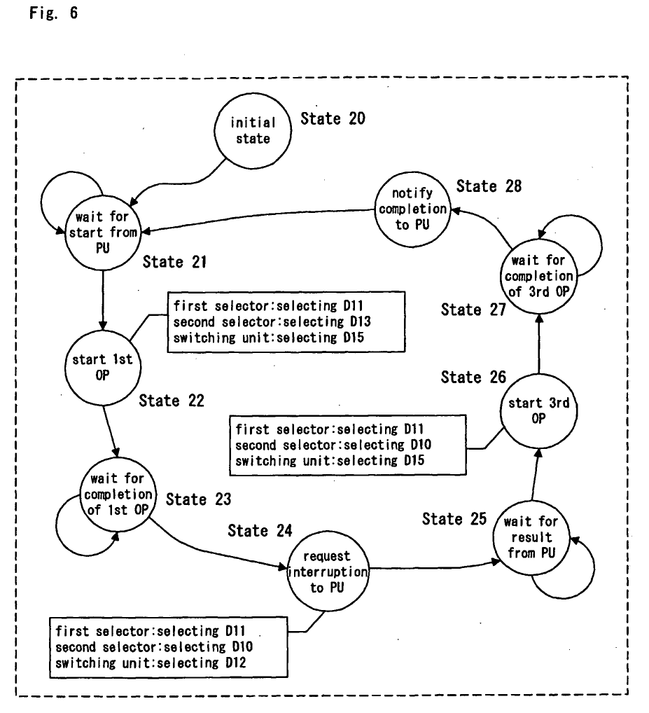

FIG. 6 illustrates the state transitions of the controller in the operation after function alteration in Embodiment 2 of the present invention.

In FIG. 6, State 20 shows the initial state, and the electronic circuit is in the reset state.

When the reset for the electronic circuit is cancelled, the state of the controller 410 is transited to State 21 from State 20. It is the state waiting for the start instruction from the processor unit 100 (it is written as “PU” in FIG. 6).

When the processor unit 100 issues the start instruction for the operating sector 400, the state is transited to State 22. At State 22, the controller 410 controls each selector such that the first selector 441 selects the data D11, the second selector 442 selects the data D13, and the switching unit 450 selects the data D15. Simultaneously, the controller 410 starts the first operating unit 421 (in FIG. 6, it is written as “1st OP”).

At State 23, the controller 410 waits for the completion of calculation processing in the first operating unit 421.

The state of the controller 410 up to State 23 is the same as the state of the processing in the normal operation mentioned above.

At State 23, when the calculation processing of the first operating unit 421 is completed, the state is transited to State 24.

At State 24, the controller 410 issues the interruption request to the processor unit 100. Simultaneously, the controller 410 controls each selector such that the first selector 441 selects the data D11, the second selector 442 selects the data D10 and the switching unit 450 selects the data D12.

At State 25, the controller 410 waits for the result of interruption processing in the processor unit 100. (In the meantime, the processor unit 100 performs interruption processing according to the flow chart shown in FIG. 5. When the processor unit 100 completes the interruption processing, the processor unit 100 issues, to the controller 410, the instruction to resume the execution thereof.)

At State 26, the controller 410 receives the instruction to resume the execution from the controller 410, and starts the third operating unit 423 (in FIG. 6, it is written as “3rd OP”). Simultaneously, the controller 410 controls each selector such that the first selector 441 selects the data D11, the second selector 442 selects the data D10, and the switching unit 450 selects the data D15.

At State 27, the controller 410 waits for the calculation completion of the third operating unit 423. (In the meantime, the third operating unit 423 performs the division operation by using the result of the processing that is substituted by the processor unit 100, and outputs the result to the register 434.)

At State 28, the controller 410 issues the notification of processing completion to the processor unit 100. Then, the state returns to State 21.

As explained above, according to the electronic circuit of the present embodiment, the processor unit 100 can substitute the processing of the second operating unit 422 in the operation after function alteration, wherein the processing includes the saturation manipulation in addition to the original processing of the second operating unit 422 described by the designed specifications.

In other words, according to the electronic circuit of the present embodiment, in the second operating unit 422, the processing not requiring the saturation manipulation (normal operation) and the processing requiring the saturation manipulation (operation after function alteration) can be realized by a simple switchover.

The above description explains for the processor unit 100 to substitute the processing of the second operating unit 422.

In FIG. 2, when the processor unit 100 substitutes the processing of the first operating unit 421, the controller 410 may control each selector such that the first selector 441 selects the data D10, the second selector 442 selects the data D13, and the switching unit 450 selects the data D15.

Moreover, when the processor unit 100 substitutes the processing of the third operating unit 423, the controller 410 may control each selector such that the first selector 441 selects the data D11, the second selector 442 selects the data D13, and the switching unit 450 selects the data D14.

Thus, according to the electronic circuit of the present embodiment, the processor unit 100 can substitute the processing of any one of a plurality of operating units, by arranging a plurality of selectors, one minus in number to the plurality of operating units, and the switching unit 450 at the last stage of the plurality of operating units. Each of the plurality of selectors selects either of the output data of the preceding operating unit and the output data of the processor unit 100, thereby inputting the selected data to the succeeding operating unit, while the switching unit 450 selects one of the output data of the plurality of operating units, and sends the selected data to the processor unit 100.

In addition, when the controller 410 is composed of a programmable circuit, the control in the operation after function alteration in each operating unit can be further simplified.

According to the present invention, it is possible to provide the electronic circuit, in which a part of the processing of the operating sector can be substituted by the processor unit.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The electronic circuit related to the present invention can be used in a signal processing integrated circuit, for example, and its applicable field, where an electronic circuit comprises a processor unit and operating units.

1. An electronic circuit comprising:
a processor unit; and
an operating sector connected to said processor unit,
wherein said operating sector includes:
a controller;
a plurality of operating units; and
a plurality of selectors,
wherein said processor unit is operable to control, through said controller, operation of said plurality of operating units and selection of said plurality of selectors, thereby substituting processing of at least one of said plurality of operating units.

2. An electronic circuit comprising:
a bus;
a processor unit connected to said bus; and
an operating sector connected to said bus,
wherein said operating sector includes:
a controller;
n-pieces of operating units (n is an integer equal to or greater than 2);
(n−1) pieces of selectors; and
a switching unit,
wherein an m-th selector among said (n−1) pieces of selectors (m is an integer greater than 0 and smaller than n) is positioned between an m-th operating unit and an (m+1)th operating unit among said n-pieces of operating units, and operable to select either of data outputted by the m-th operating unit and data inputted to said operating sector by said processor unit via said bus, thereby inputting the selected data to the (m+1)th operating unit,
wherein said switching unit is operable to select one of n-pieces of data fed respectively by said n-pieces of operating units and output the selected data to said processor unit via said bus,
wherein said controller, in response to an instruction by said processor unit, is operable to control selection of said (n−1) pieces of selectors and selection of said switching unit, and to notify said processor unit of results of the selection, and
wherein said processor unit, upon receipt of the results of the selection, is operable to process the data outputted by said switching unit and to input the processed data to said operating sector, thereby substituting processing of at least one of said plurality of operating units.

3. The electronic circuit as defined in claim 2, wherein said processor unit includes:
an interruption controller, and
wherein said controller is operable to issue to said interruption controller interruption request requesting substitution of processing of at least one of said n-pieces of operating units.

4. The electronic circuit as defined in claim 2, wherein when an operating unit of said n-pieces of operating units changes contents of processing, said processor unit substitutes the processing of the operating unit.

5. The electronic circuit as defined in claim 2, wherein when an operating unit of said n-pieces of operating units falls into functional disorder, said processor unit substitutes processing of the operating unit.

6. The electronic circuit as defined in claim 2, wherein said operating sector includes wired logic circuits.

7. The electronic circuit as defined in claim 2, wherein said operating sector includes programmable logic circuits.
